(19) United States
(12) Patent Application Publication
(10) Pub. No.: US 2025/0289321 A1
(43) Pub. Date: Sep. 18, 2025

(54) MOTOR CONTROL DEVICE FOR ELECTRIC PROPULSION MACHINE

(71) Applicant: SUZUKI MOTOR CORPORATION, Hamamatsu-shi (JP)

(72) Inventor: Hiroki INATA, Hamamatsu-shi (JP)

(73) Assignee: SUZUKI MOTOR CORPORATION, Hamamatsu-shi (JP)

(21) Appl. No.: 19/051,707

(22) Filed: Feb. 12, 2025

(30) Foreign Application Priority Data
Mar. 13, 2024 (JP) 2024-039319

(51) Int. Cl. B60L 15/20; B60L 7/10

(52) U.S. Cl. CPC B60L 15/2009; B60L 7/10; B60L 2200/32; B60L 2240/12; B60L 2240/14; B60L 2240/421; B60L 2240/423

(57) ABSTRACT

A motor control device for an electric propulsion machine is configured to control a motor of the electric propulsion machine. The electric propulsion machine includes a propeller and the motor configured to rotate the propeller. The motor control device includes: a drive control unit configured to perform drive control of the motor to rotate the propeller; a jump determination unit configured to determine whether a ship equipped with the electric propulsion machine jumps; and a regenerative control unit configured to perform regenerative control of the motor in response to the ship being determined to jump as a result of a determination by the jump determination unit.

### CROSS-REFERENCE TO RELATED APPLICATIONS

This application is based on and claims priority under 35 USC 119 from Japanese Patent Application No. 2024-039319 filed on Mar. 13, 2024, the contents of which are incorporated herein by reference.

### TECHNICAL FIELD

The present disclosure relates to a motor control device configured to control a motor of an electric propulsion machine.

### BACKGROUND ART

For example, JP2007-125909A describes a ship propulsion machine for propelling a ship that uses a motor (electric motor) as a power source for rotating a propeller. The electric propulsion machine here means a machine such as the electric ship propulsion machine.

Recently, following the electrification of automobiles, the electrification of ship propulsion machines has been promoted, and the adoption of electric propulsion machines is expected to increase further in the future.

### SUMMARY OF INVENTION

The motor mounted on a moving object functions as a generator when the moving object decelerates, and performs a regenerative operation that converts the kinetic energy of the moving object into electrical energy. The electric energy obtained by the regenerative operation of the motor can be stored in an electric storage device such as a battery or a capacitor and then used to drive the motor, thereby increasing the cruising range of the moving object.

Since automobiles often start and stop repeatedly during the process of movement, deceleration is frequently performed. Furthermore, in the automobiles, due to the low running resistance of the vehicle, the deceleration takes a longer time. For example, it takes a long time for the automobile to come to a stop after the driver releases the accelerator. For these reasons, in electric vehicles or hybrid vehicles, opportunities or time can sufficiently be ensured for the motor to perform a regenerative operation.

On the other hand, in a ship, there are fewer starts and stops in the process of movement than in an automobile, resulting in a lower frequency of deceleration. Furthermore, in a ship, the time required for deceleration is short due to the high resistance of water that is applied to the ship during navigation. For example, when a ship operator returns the lever of a remote control device for a ship propulsion machine from a forward position to a neutral position, the ship comes to a stop in a short period of time. For these reasons, in electric propulsion machines, it may be difficult to ensure sufficient opportunities or time for the motor to perform a regenerative operation.

On the other hand, in ships, during navigation, the ship may ride a wave and jump above the water surface. In a case where a ship is equipped with an electric propulsion machine and the ship is navigating using the propulsive force generated by the electric propulsion machine, when the ship jumps, the propeller of the electric propulsion machine comes out above the water surface. When the propeller of the electric propulsion machine rises above the water surface, the resistance of the water acting on the propeller disappears, and thus the rotation speed of the motor that rotates the propeller in the electric propulsion machine suddenly increases, causing the motor to rotate at an excessively high speed.

Excessively high speed rotation of the motor may have adverse effects on the motor. In addition, the excessively high speed rotation of the motor may also have adverse effects on the bearings that support the propeller shaft or the like, or on the gear mechanism or the like in a case where a gear mechanism is interposed between the motor and the propeller shaft. For example, the excessively high speed rotation of the motor may shorten the life of the motor, bearing, gear mechanism, and the like.

The present disclosure has been made in view of the above-mentioned problems, and an object thereof is, for example, to provide a motor control device for an electric propulsion machine that can increase opportunities or time for the motor to perform a regenerative operation and can suppress adverse effects on the motor or the like when the ship jumps.

In one aspect of the present disclosure, there is provided a motor control device for an electric propulsion machine, the motor control device being configured to control a motor of the electric propulsion machine, the electric propulsion machine including a propeller and the motor configured to rotate the propeller, the motor control device including: a drive control unit configured to perform drive control of the motor to rotate the propeller; a jump determination unit configured to determine whether a ship equipped with the electric propulsion machine jumps; and a regenerative control unit configured to perform regenerative control of the motor in response to the ship being determined to jump as a result of a determination by the jump determination unit.

According to the present disclosure, by performing the regenerative control of the motor when the ship jumps, it is possible to increase opportunities or time for the motor to perform a regenerative operation. Further, according to the present disclosure, by performing the regenerative control of the motor when the ship jumps, the regenerative braking can be applied to the motor, and an increase in rotation speed of the motor can be suppressed. Therefore, it is possible to suppress the excessively high speed of the motor and the adverse effects on the motor or the like.

### BRIEF DESCRIPTION OF DRAWINGS

The present disclosure will be described in detail based on the following without being limited thereto, wherein:

FIG. 1A is an external view illustrating a ship equipped with a ship propulsion system including a motor control device according to an embodiment of the present disclosure, and FIG. 1B is an explanatory view illustrating a state where the ship is in a jumping state;

FIG. 2 is a block diagram illustrating a ship propulsion system including the motor control device according to the embodiment of the present disclosure;

FIG. 3 is an explanatory diagram illustrating a remote control device;

FIG. 4 is a flowchart illustrating a motor control process in the motor control device according to the embodiment of the present disclosure;

FIG. 5 is a flowchart illustrating a water landing determination process in the motor control device according to the embodiment of the present disclosure;

FIG. 6 is a flowchart illustrating a regenerative control process in the motor control device according to the embodiment of the present disclosure;

FIG. 7 is a timing chart illustrating an example of changes in required drive torque, required regenerative torque, upward or downward acceleration of the ship, ship speed, rotation speed of the motor, and the like when the motor control process is performed and a ship navigating forward jumps, in the motor control device according to the embodiment of the present disclosure; and

FIG. 8 is a timing chart illustrating another example of changes in required drive torque, required regenerative torque, upward or downward acceleration of the ship, ship speed, rotation speed of the motor, and the like when the motor control process is performed and a ship navigating forward jumps, in the motor control device according to the embodiment of the present disclosure.

### DESCRIPTION OF EMBODIMENTS

A motor control device for an electric propulsion machine according to an embodiment of the present disclosure is a motor control device configured to control a motor of the electric propulsion machine including a propeller and a motor configured to rotate the propeller. In the motor control device of this embodiment, the motor is, for example, an AC synchronous motor, and torque-based control, for example, is employed for higher-level control of the motor, and vector control, for example, is employed for lower-level control of the motor. Further, the motor control device of this embodiment includes a drive control unit, a jump determination unit, and a regenerative control unit.

The drive control unit is configured to perform drive control of the motor and to rotate the propeller. Specifically, a ship equipped with an electric propulsion machine is equipped with an operation device (for example, a remote control device) for a ship operator to operate the electric propulsion machine, and the operation device includes, for example, an operating lever. The ship operator tilts the operating lever forward when moving the ship forward, tilts the operating lever backward when moving the ship backward, and returns the operating lever to a neutral position when stopping the ship. The operation device outputs an operation signal indicating, for example, an inclination direction and an inclination angle (operation amount) of the operating lever. The drive control unit performs drive control of the motor based on the operation signal. When the ship operator tilts the operating lever forward or backward, the drive control unit drives the motor such that the rotor of the motor rotates in a direction corresponding to the inclination direction of the operating lever indicated by the operation signal, and the motor generates a drive torque corresponding to the inclination angle of the operating lever indicated by the operation signal. Accordingly, the propeller rotates, and a propulsive force that moves the ship forward or backward is generated. The direction of the propulsive force at that time corresponds to the inclination direction of the operating lever, and the magnitude of the propulsive force at that time corresponds to the inclination angle of the operating lever. For example, when a ship operator tilts the operating lever forward greatly, the ship moves forward at high speed, and the ship enters a navigating state.

The jump determination unit is configured to determine whether a ship equipped with an electric propulsion machine jumped. The expression “jump of a ship” as used herein means that the ship moves upward and the propeller of the electric propulsion machine comes out of the water surface while the ship is navigating. A ship may ride a wave and jump during navigation, and when the ship is navigating at high speed, for example, when the ship is planing, the frequency of the ship jumping increases. Whether the ship jumps can be determined, for example, based on the rotation speed of the motor. That is, during the drive control of the motor, the drive control unit always recognizes the angle or angular velocity of the rotor of the motor, and performs control to synchronize the rotation of the rotating magnetic field and the rotation of the rotor based on the angle or angular velocity of the rotor. When the ship is navigating through the drive control of the motor by the drive control unit, when the ship jumps and the propeller of the electric propulsion machine comes out of the water surface, the resistance of water applied to the propeller disappears, and the load on the motor suddenly decrease. For example, when the load on the motor suddenly decreases in a state where the motor is rotating and generating a certain drive torque, the angular velocity of the rotor of the motor suddenly increases. The drive control unit detects the increase in the angular velocity of the rotor, and increases the rotational angular velocity of the rotating magnetic field to follow the increase in the angular velocity of the rotor. As a result, the rotation speed of the motor suddenly increases. In this manner, when the ship jumps, the rotation speed of the motor suddenly increases, and thus it can be determined whether the ship jumps based on the rotation speed of the motor.

The regenerative control unit is configured to perform regenerative control of the motor in response to the ship jumps being determined to jump a result of the determination by the jump determination unit. That is, when the ship jumps, control of the motor is switched from drive control by the drive control unit to regenerative control by the regenerative control unit. After the motor control is switched to regenerative control, the propeller and the rotor of the motor continue to rotate due to inertia. Through the regenerative control, the motor performs regenerative operation and functions as a generator. Accordingly, the kinetic energy of the rotation of the rotor is converted into electrical energy.

By performing the regenerative control of the motor when the ship jumps, it is possible to increase opportunities or time for the motor to perform the regenerative operation. The electric energy obtained by the regenerative operation of the motor can be stored in an electric storage device such as a battery or a capacitor and then used to drive the motor, thereby extending the cruising distance of the ship.

Further, due to the regenerative operation of the motor, a regenerative braking is applied to the motor. When a ship jumps, the rotation speed of the motor suddenly increases, but due to regenerative braking, the degree to which the rotation speed of the motor increases is reduced. Accordingly, it is possible to prevent the motor from rotating at an excessively high speed, and it is possible to suppress the adverse effects on the motor or the like caused by excessively high speed rotation.

### (Ship)

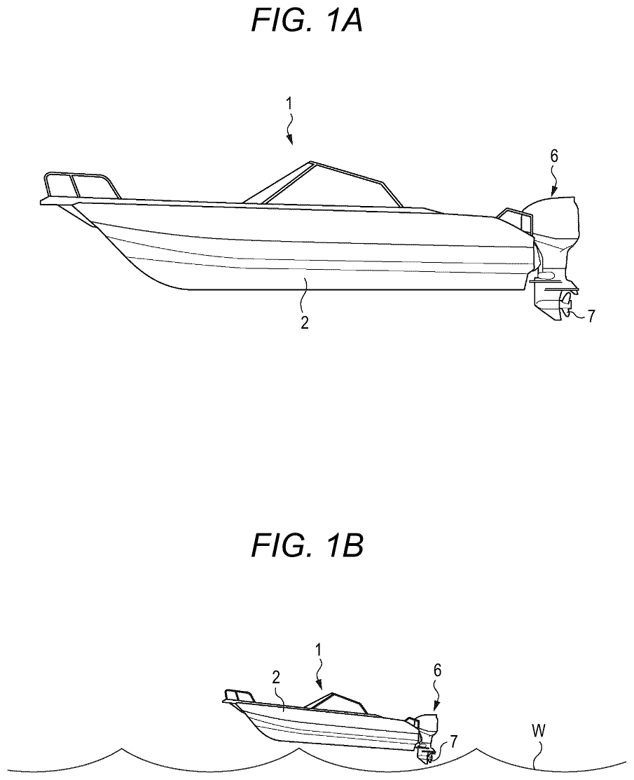

FIG. 1A illustrates a ship 1 equipped with a ship propulsion system 5 including a motor control device 21 according to an embodiment of the present disclosure.

The ship 1 is, for example, a small ship as illustrated in FIG. 1A, and specifically, a leisure boat, a fishing boat, a sports boat, a cruiser, a fishing boat, or the like. Note that the present disclosure is applicable not only to such small-sized ships but also to medium-sized or large-sized ships.

Furthermore, an electric outboard motor 6 is provided at the rear of a hull 2 of the ship 1. The electric outboard motor 6 is one type of electric propulsion machine. Although the motor control device 21 of this embodiment is a device for controlling the motor 8 of the electric outboard motor 6, the motor control device of the present disclosure can also be applied to control motors of other types of electric propulsion machines such as electric outboard motors and electric inboard motors.

### (Ship Propulsion System)

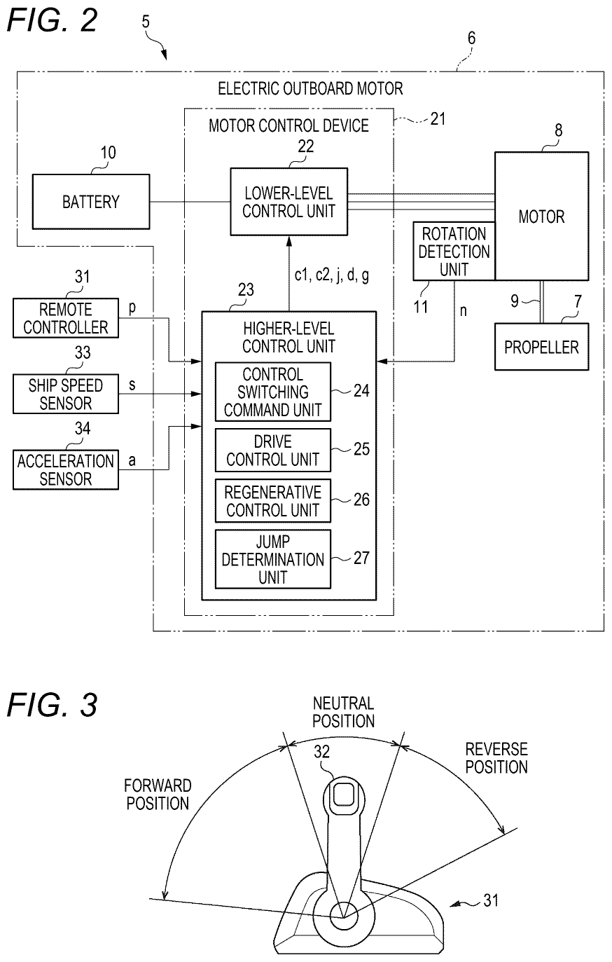

FIG. 2 illustrates the configuration of the ship propulsion system 5. The ship propulsion system 5 is a system for propelling the ship 1, and is provided in the ship 1. As illustrated in FIG. 2, the ship propulsion system 5 includes the electric outboard motor 6, a remote control device (remote controller) 31, a ship speed sensor 33, and an acceleration sensor 34. Further, the electric outboard motor 6 includes a propeller 7, a motor 8, a battery 10, a rotation detection unit 11, and a motor control device 21. Note that the battery 10 may be provided outside the electric outboard motor 6, for example, in the hull 2 of the ship 1. Further, the motor control device 21 may be provided outside the electric outboard motor 6, for example, in the hull 2 of the ship 1.

The propeller 7 is a device that generates a propulsive force for the ship 1 by rotating. The motor 8 is a power source that rotates the propeller 7. For example, the motor 8 is an AC motor, specifically a three-phase synchronous motor. Although not illustrated in detail, there is a power transmission mechanism 9 (for example, a drive shaft, a gear mechanism, a propeller shaft, and the like) that transmits the power of the motor 8 to the propeller 7 is provided between the motor 8 and the propeller 7. The battery 10 is a secondary battery that supplies the motor 8 with electric power for driving the motor.

The rotation detection unit 11 is a device that detects the angle or angular velocity of the rotor of the motor 8 and a rotation speed n of the motor 8. The rotation detection unit 11 outputs a detection signal indicating the angle or angular velocity of the rotor of the motor 8 to a lower-level control unit 22. Further, the rotation detection unit 11 outputs a detection signal indicating the rotation speed n of the motor 8 to a higher-level control unit 23. Note that, for example, a rotation detection unit that detects only the angle of the rotor of the motor 8 may be provided, the lower-level control unit 22 may calculate the angular velocity of the motor 8 based on the detection signal from the rotation detection unit, and the higher-level control unit 23 may calculate the rotation speed of the motor 8 based on the detection signal from the rotation detection unit.

The remote controller 31 is a device for operating the electric outboard motor 6. As illustrated in FIG. 3, the remote controller 31 has an operating lever 32 for a ship operator to input an operation. As illustrated in FIG. 2, the remote controller 31 outputs an operation signal p indicating the inclination direction and the inclination angle (operation amount) of the operating lever 32 to the higher-level control unit 23.

The ship speed sensor 33 is a device that detects the speed of the ship 1 (ship speed s). The ship speed sensor 33 outputs a detection signal indicating the ship speed s to the higher-level control unit 23.

The acceleration sensor 34 is a device that detects the acceleration of the ship 1. The acceleration sensor 34 can detect upward acceleration and downward acceleration of the ship 1. The acceleration sensor 34 outputs a detection signal indicating the upward or downward acceleration a of the ship 1 to the higher-level control unit 23. In the embodiment, when the acceleration a has a positive value, the acceleration a indicates an upward acceleration of the ship 1, and when the acceleration a has a negative value, the acceleration a indicates a downward acceleration of the ship 1.

### (Motor Control Device)

The motor control device 21 is a device that controls the motor 8. In the embodiment, the motor control device 21 employs torque-based control as a higher-level control method for the motor 8, and employs vector control as a lower-level control method for the motor 8. The motor control device 21 has the lower-level control unit 22 and the higher-level control unit 23, as illustrated in FIG. 2. The motor control device 21 has a structure in which the higher-level control unit 23 controls the lower-level control unit 22, and the lower-level control unit 22 controls the motor 8 under the control of the higher-level control unit 23. The higher-level control unit 23 has an arithmetic processing unit, a storage device, and the like. The lower-level control unit 22 includes a vector control circuit, a pulse width modulation (PWM) inverter circuit, and the like.

The higher-level control unit 23 functions as a control switching command unit 24, a drive control unit 25, a regenerative control unit 26, and a jump determination unit 27 by executing a computer program stored in a storage device included in the higher-level control unit 23, for example.

The control switching command unit 24 switches the control of the lower-level control unit 22. Specifically, the control switching command unit 24 outputs a drive control command signal c1 to the lower-level control unit 22 when the drive control unit 25 performs drive control of the motor 8. As a result, the state of the lower-level control unit 22 becomes a state where the drive control of the motor 8 is performed in cooperation with the drive control unit 25 of the higher-level control unit 23. Further, the control switching command unit 24 outputs a regenerative control command signal c2 to the lower-level control unit 22 when the regenerative control unit 26 performs regenerative control of the motor 8. As a result, the state of the lower-level control unit 22 becomes a state where the regenerative control of the motor 8 is performed in cooperation with the regenerative control unit 26 of the higher-level control unit 23.

The drive control unit 25 performs drive control of the motor 8. Specifically, the drive control unit 25 outputs a command signal indicating a rotation direction instruction j and a required drive torque d to the lower-level control unit 22. The lower-level control unit 22 drives the motor 8 based on the command signal and the angle or angular velocity of the rotor of the motor 8 output from the rotation detection unit 11. Specifically, the lower-level control unit 22 drives the motor 8 such that the rotation direction of the rotor of the motor 8 is the rotation direction indicated by the rotation direction instruction j, and the drive torque generated by the motor 8 is a drive torque corresponding to the required drive torque d. The drive torque generated by the motor 8 increases as the required drive torque d increases.

The drive control unit 25 normally performs drive control of the motor 8 corresponding to the operation of the operating lever 32 of the remote controller 31 when the regenerative control process to be described later is not performed. Specifically, the drive control unit 25 determines the rotation direction instruction j and the required drive torque d in accordance with the operation of the operating lever 32 of the remote controller 31. That is, in FIG. 3, when moving the ship 1 forward, the ship operator tilts the operating lever 32 forward to place the operating lever in the forward position. Further, when the ship operator moves the ship 1 backward, the ship operator tilts the operating lever 32 backward to place the operating lever in the backward position. Furthermore, when stopping the ship 1, the ship operator places the operating lever 32 in the neutral position. As illustrated in FIG. 2, the remote controller 31 outputs an operation signal p indicating the inclination direction and the inclination angle (operation amount) of the operating lever 32 to the higher-level control unit 23. The drive control unit 25 determines the rotation direction instruction j based on the inclination direction of the operating lever 32 indicated by the operation signal p. Specifically, in a case where the inclination direction of the operating lever 32 indicated by the operation signal p is forward, the drive control unit 25 sets the rotation direction instruction j to an instruction to change the rotation direction of the motor 8 to one direction, and in a case where the inclination direction of the operating lever 32 indicated by the operation signal p is backward, the drive control unit 25 sets the rotation direction instruction j to an instruction to change the rotation direction of the motor 8 to another direction. Further, the drive control unit 25 determines the required drive torque d based on the inclination angle of the operating lever 32 indicated by the operation signal p. The drive control unit 25 increases the required drive torque d as the inclination angle of the operating lever 32 indicated by the operation signal p increases.

The lower-level control unit 22 controls the motor 8 based on the command signal indicating the rotation direction instruction j and the required drive torque d determined in this manner, as well as the angle or angular velocity of the rotor of the motor 8 output from the rotation detection unit 11, and accordingly, the rotor of the motor 8 rotates in a direction corresponding to the inclination direction of the operating lever 32, and the drive torque generated by the motor 8 becomes a drive torque corresponding to the inclination angle of the operating lever 32. As a result, when the ship operator tilts the operating lever 32 forward to the forward position, the propeller rotates in the forward direction, a propulsive force that moves the ship 1 forward is generated, and the greater the forward inclination angle of the operating lever 32, the greater the propulsive force that moves the ship 1 forward. In addition, when the ship operator tilts the operating lever 32 backward to the reverse position, the propeller rotates in the reverse direction, a propulsive force that moves the ship 1 backward is generated, and the greater the backward inclination angle of the operating lever 32, the greater the propulsive force that moves the ship 1 backward.

Further, the drive control unit 25 performs drive control of the motor 8 independent of the operation of the operating lever 32 of the remote controller 31 in the regenerative control process to be described later. Specifically, in the regenerative control process, the drive control unit 25 sets the required drive torque d to 0 regardless of the inclination angle of the operating lever 32 immediately before the start of regenerative control of the motor, and gradually increases the required drive torque d from 0 regardless of the inclination angle of the operating lever 32 after the end of the regenerative control of the motor. These will be detailed later.

The regenerative control unit 26 performs regenerative control of the motor 8. Specifically, the regenerative control unit 26 determines a required regenerative torque g, and outputs a command signal indicating the required regenerative torque g to the lower-level control unit 22. Based on the command signal and the like, the lower-level control unit 22 controls the induced current flowing through the stator coil of the motor 8 such that the regenerative torque generated in the motor 8 is a regenerative torque corresponding to the required regenerative torque g. Note that the regenerative torque is a torque in a direction opposite to the rotation direction of the rotor at that time, and is generated by the regenerative operation of the motor 8. In the regenerative control process to be described later, the regenerative control unit 26 determines the required regenerative torque g (required regenerative torque initial value Gs) based on a rotation speed increase rate r per unit time of the motor 8 at a start of jump of the ship 1, and after that, the required regenerative torque g gradually decreases. This will be explained in detail later.

The jump determination unit 27 determines whether the ship 1 jumps. Specifically, the jump determination unit 27 determines whether the ship 1 starts jumping. The expression “jump” of the ship 1 means that the ship 1 moves upward and the propeller 7 of the electric outboard motor 6 comes out of the water surface while the ship 1 is navigating. The ship 1 may ride a wave and jump during navigation, and when the ship 1 is navigating at high speed, for example, when the ship 1 is planing, the frequency of jumping of the ship 1 increases. FIG. 1B illustrates an example of how the ship 1 jumps. Note that W in FIG. 1B represents the water surface. When the jump determination unit 27 determines that the ship 1 starts jumping, the regenerative control process is started, and in the regenerative control process, the regenerative control and the like of the motor 8 are performed. These will be detailed later. Further, the jump determination unit 27 also determines whether the ship 1 that jumped lands on the water.

### (Motor Control Process, Jump Start Determination Process)

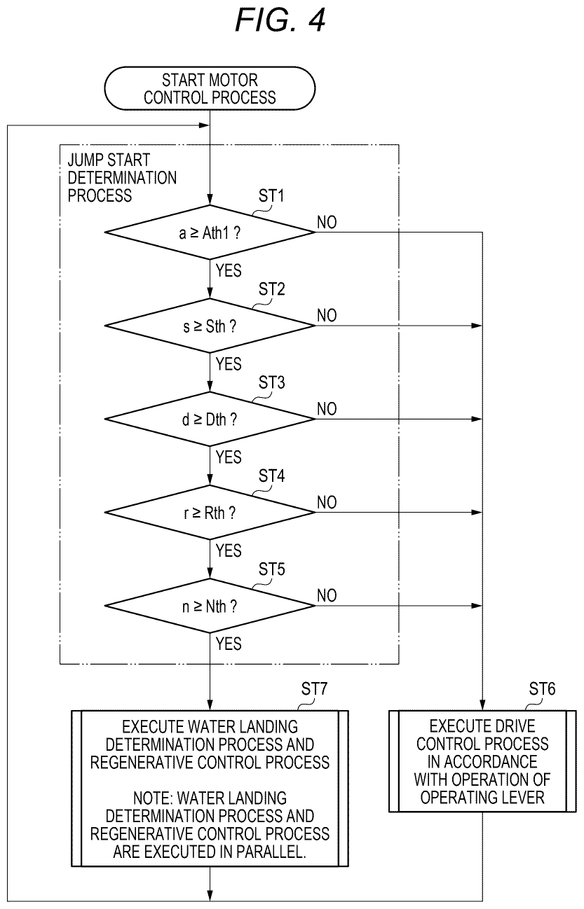

FIG. 4 illustrates a motor control process in the motor control device 21. As illustrated in FIG. 4, in the motor control process, a jump start determination process (steps ST1 to ST5), a drive control process corresponding to the operation of the operating lever (step ST6), a water landing determination process (step ST7), and a regenerative control process (step ST7) are executed.

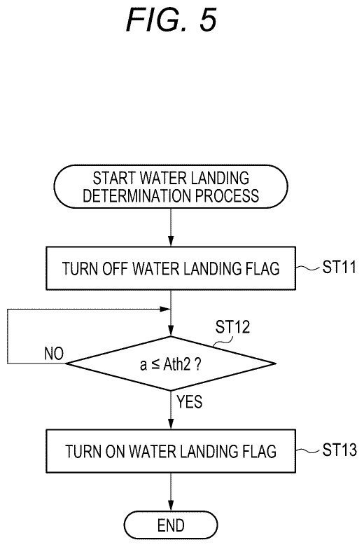

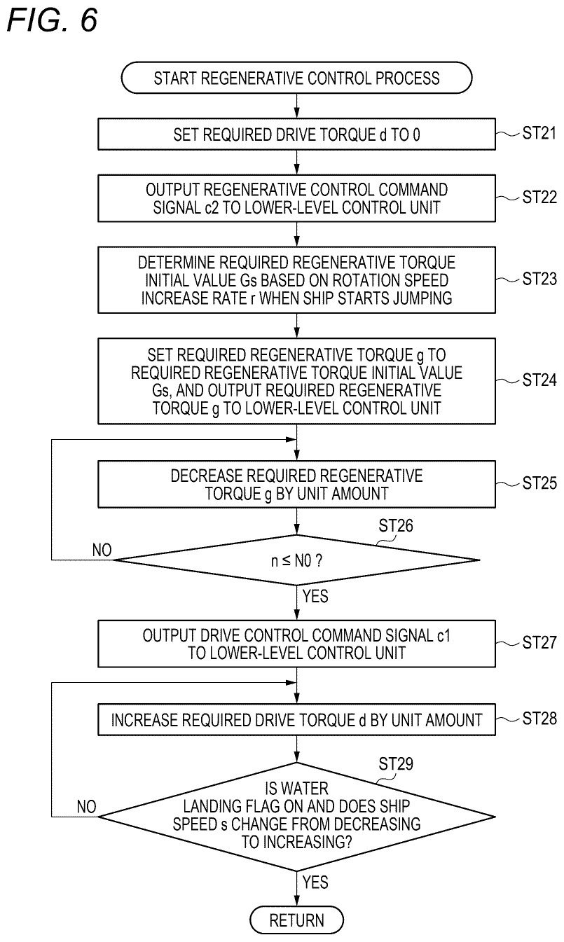

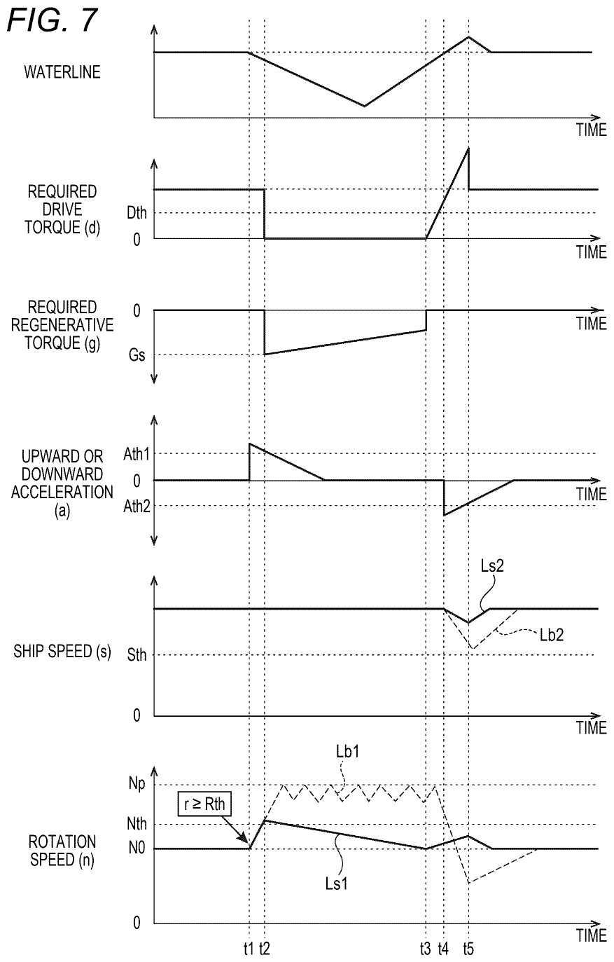

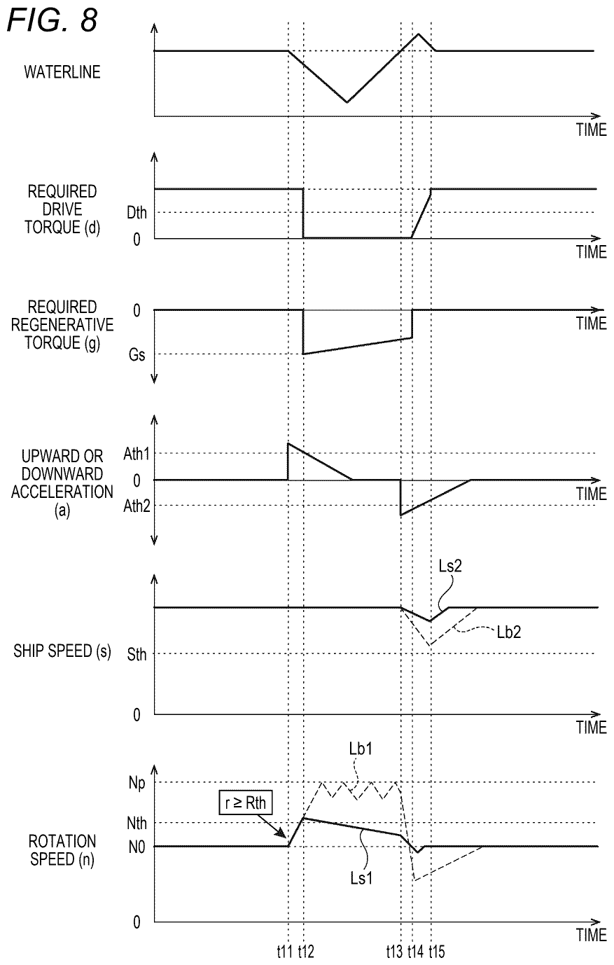

FIG. 5 illustrates the water landing determination process. FIG. 6 illustrates the regenerative control process. FIG. 7 illustrates an example of a change in required drive torque d, required regenerative torque g, upward or downward acceleration a of the ship 1, ship speed s, rotation speed of the motor 8, and the like when the motor control process illustrated in FIG. 4 is performed and the ship 1 navigating forward jumps. FIG. 8 illustrates another example of a change in required drive torque d, required regenerative torque g, upward or downward acceleration a of the ship 1, ship speed s, rotation speed of the motor 8, and the like when the motor control process illustrated in FIG. 4 is performed and the ship 1 navigating forward jumps. In addition, in FIGS. 7 and 8, for the graphs of the required regenerative torque g, the downward direction is the increasing direction, and for the other graphs, the upward direction is the increasing direction. In addition, in the graphs of the upward or downward acceleration a in FIGS. 7 and 8, the value above 0 is the upward acceleration a of the ship 1, and the value below 0 is the downward acceleration a of the ship 1 (as described above, the upward acceleration a is a positive value, and the downward acceleration a is a negative value). In addition, in FIGS. 7 and 8, in order to show the timing and behavior of the jump of the ship 1, a graph showing the change in the waterline of the ship 1 is added at the top of each of the drawings.

While the ship propulsion system 5 is in operation, the motor control process consisting of steps ST1 to ST7 in FIG. 4 is repeatedly executed. Furthermore, when the ship propulsion system 5 starts operating (for example, immediately before the start of motor control process), the lower-level control unit 22 enters the initial state. The initial state of the lower-level control unit 22 becomes a state where the drive control of the motor 8 is performed in cooperation with the drive control unit 25 of the higher-level control unit 23.

In the motor control process illustrated in FIG. 4, first, the jump determination unit 27 performs a jump start determination process (steps ST1 to ST5). The jump start determination process is a process of determining whether the ship 1 starts jumping. In the embodiment, the jump determination unit 27 determines whether the ship 1 starts jumping based on the upward acceleration a of the ship 1, the ship speed s of the ship 1, the required drive torque d, the rotation speed increase rate r of the motor 8 per unit time, and the rotation speed n of the motor 8.

In the jump start determination process, the jump determination unit 27 first recognizes the current upward acceleration a of the ship 1 based on the detection signal output from the acceleration sensor 34, and determines whether the acceleration a is equal to or greater than a predetermined upward acceleration reference value Ath1 (step ST1). When the current upward acceleration a of the ship 1 is equal to or greater than the upward acceleration reference value Ath1, the jump determination unit 27 recognizes the current ship speed s of the ship 1 based on the detection signal output from the ship speed sensor 33, and determines whether the ship speed s is equal to or greater than a predetermined ship speed reference value Sth (step ST2). When the current ship speed s of the ship 1 is equal to or greater than the ship speed reference value Sth, the jump determination unit 27 determines whether the required drive torque d currently output by the drive control unit 25 to the lower-level control unit 22 is equal to or greater than a predetermined required drive torque reference value Dth (step ST3). In a case where the current required drive torque d is equal to or greater than the required drive torque reference value Dth, the jump determination unit 27 calculates the current rotation speed increase rate r per unit time of the motor 8 based on the detection signal output from the rotation detection unit 11, and determines whether the rotation speed increase rate r is equal to or greater than a predetermined rotation speed increase rate reference value Rth (step ST4). When the current rotation speed increase rate r per unit time of the motor 8 is equal to or greater than the rotation speed increase rate reference value Rth, the jump determination unit 27 monitors the rotation speed n of the motor 8 based on the detection signal output from the rotation detection unit 11, and determines whether the rotation speed n of the motor 8 increases to a predetermined rotation speed reference value Nth or greater (step ST5).

In addition, in the jump start determination process, the order of determining whether the current acceleration a is equal to or greater than the upward acceleration reference value Ath1, whether the current ship speed s is equal to or greater than the ship speed reference value Sth, whether the current required drive torque d is equal to or greater than the required drive torque reference value Dth, and whether the current rotation speed increase rate r per unit time is equal to or greater than the rotation speed increase rate reference value Rth is not limited to the order illustrated in FIG. 4. The order in which these determinations are made can be reversed. However, determining whether the current rotation speed increase rate r per unit time is equal to or greater than the rotation speed increase rate reference value Rth is made after determining whether the current acceleration a is equal to or greater than the upward acceleration reference value Ath1.

In a case where the current acceleration a is not equal to or greater than the upward acceleration reference value Ath1, the current ship speed s is not equal to or greater than the ship speed reference value Sth, the current required drive torque d is not equal to or greater than the required drive torque reference value Dth, the current rotation speed increase rater per unit time is not equal to or greater than the rotation speed increase rate reference value Rth, and the rotation speed n does not increase to the rotation speed reference value Nth or greater, the jump determination unit 27 determines that the ship 1 starts jumping. As a result of the determination by the jump determination unit 27, in a case where the ship 1 does not start jumping, the drive control unit 25 executes the drive control process corresponding to the operation of the operating lever 32 (step ST6).

The drive control process corresponding to the operation of the operating lever 32 is a process of driving the motor 8 corresponding to the operation of the operating lever 32. At the start of the drive control process corresponding to the operation of the operating lever 32, the drive control unit 25 determines the rotation direction instruction j in accordance with the inclination direction of the operating lever 32 indicated by the operation signal p output from the remote controller 31, determines the required drive torque d in accordance with the inclination angle of the operating lever 32 indicated by the operation signal p, and outputs a command signal indicating the rotation direction instruction j and the required drive torque d to the lower-level control unit 22. After that, the process returns to step ST1. Since the motor control process is repeatedly executed while the ship propulsion system 5 is in operation, while the ship 1 has not started jumping, the process of step ST6, that is, the drive control process corresponding to the operation of the operating lever 32, is performed. During this time, the drive control unit 25 outputs a command signal indicating the rotation direction instruction j and the required drive torque d to the lower-level control unit 22. During this time, when the inclination direction of the operating lever 32 indicated by the operation signal p output from the remote controller 31 is switched, the drive control unit 25 changes the rotation direction instruction j in accordance with the switching of the inclination direction of the operating lever 32, and, when the inclination angle of the operating lever 32 indicated by the operation signal p changes, the drive control unit 25 changes the required drive torque d in accordance with the change in the inclination angle of the operating lever 32. The lower-level control unit 22 drives the motor 8 based on the command signal output from the drive control unit 25. As a result, the motor 8 is driven in accordance with the operation of the operating lever 32.

On the other hand, in a case where the current acceleration a is equal to or greater than the upward acceleration reference value Ath1, the current ship speed s is equal to or greater than the ship speed reference value Sth, the current required drive torque d is equal to or greater than the required drive torque reference value Dth, the current rotation speed increase rate r per unit time is equal to or greater than the rotation speed increase rate reference value Rth, and the rotation speed n increases to the rotation speed reference value Nth or greater, the jump determination unit 27 determines that the ship 1 starts jumping.

The ship 1 is likely to jump while navigating at high speed. Whether the ship 1 is navigating at high speed and is in a state of being easy to jump can be estimated based on the ship speed s of the ship 1. The ship speed reference value Sth is a value indicating the ship speed of the ship 1 when the ship 1 navigates at high speed and jumps, and is, for example, a value determined by a prior experiment or simulation. By determining whether the ship speed s of the ship 1 is equal to or greater than the ship speed reference value Sth, it is possible to estimate whether the ship 1 is navigating at high speed and is in a state of being easy to jump.

Furthermore, when the ship operator tilts the operating lever 32 of the remote controller 31 to a greater extent, the required drive torque d becomes larger, the drive torque of the motor 8 becomes larger, and the propulsive force of the ship 1 becomes larger. As a result, the ship 1 navigates at high speed and is in a state of being easy to jump. Therefore, whether the ship 1 is navigating at high speed and is in a state of being easy to jump can be estimated based on the required drive torque d. The required drive torque reference value Dth is a value indicating the required drive torque when the ship 1 navigates at high speed and jumps, and is, for example, a value determined by a prior experiment or simulation. By determining whether the required drive torque d is equal to or greater than the required drive torque reference value Dth, it is possible to estimate whether the ship 1 is navigating at high speed and is in a state of being easy to jump.

Further, when the ship 1 starts jumping, the ship 1 suddenly moves significantly upward. Whether the ship 1 suddenly moves significantly upward can be determined based on the upward acceleration a of the ship 1. The upward acceleration reference value Ath1 is a value indicating the upward acceleration of the ship 1 when the ship 1 jumps, and is, for example, a value determined by a prior experiment or simulation. By determining whether the upward acceleration a of the ship 1 is equal to or greater than the upward acceleration reference value Ath1, it is possible to estimate whether the ship 1 starts jumping.

Further, when the ship 1 starts jumping, the propeller 7 comes out of the water surface, and the resistance of water applied to the propeller 7 is eliminated, and thus the rotation speed of the motor 8 suddenly increases significantly. A sudden large increase in the rotation speed of the motor 8 can be detected based on the rotation speed increase rate r per unit time of the motor 8 and the rotation speed n of the motor 8 immediately after the sudden increase. The rotation speed increase rate reference value Rth is a value indicating the rotation speed increase rate per unit time of the motor 8 when the ship 1 starts jumping. Further, the rotation speed reference value Nth is a value indicating the rotation speed of the motor 8 immediately after the ship 1 starts jumping. These values are determined, for example, by a prior experiment or simulation. By determining whether the rotation speed increase rate r per unit time of the motor 8 is equal to or greater than the rotation speed increase rate reference value Rth, and whether the rotation speed n of the motor 8 immediately after the sudden increase is equal to or greater than the rotation speed reference value Nth, it is possible to estimate whether the ship 1 starts jumping.

Therefore, in a case where the current acceleration a is equal to or greater than the upward acceleration reference value Ath1, the current ship speed s is equal to or greater than the ship speed reference value Sth, the current required drive torque d is equal to or greater than the required drive torque reference value Dth, the current rotation speed increase rate r per unit time is equal to or greater than the rotation speed increase rate reference value Rth, and the rotation speed n increases to the rotation speed reference value Nth or greater, by determining that the ship 1 starts jumping, it is possible to determine that the ship 1 starts jumping with high accuracy.

Here, the jump start determination process will be specifically explained using FIG. 7. At time t1 in FIG. 7, the acceleration a is equal to or greater than the upward acceleration reference value Ath1, the ship speed s is equal to or greater than the ship speed reference value Sth, and the required drive torque d is or equal to or greater than the required drive torque reference value Dth, and the rotation speed increase rate r per unit time is equal to or greater than the rotation speed increase rate reference value Rth. Further, at time t2, the rotation speed n has increased to the rotation speed reference value Nth or greater. In this case, at time t2, the jump determination unit 27 determines that the ship 1 starts jumping.

In the jump start determination process illustrated in FIG. 4, when the jump determination unit 27 determines that the ship 1 starts jumping, the water landing determination process and the regenerative control process are executed (step ST7). The water landing determination process and the regenerative control process are executed in parallel with each other.

### (Water Landing Determination Process)

In the water landing determination process illustrated in FIG. 5, first, the jump determination unit 27 initializes the water landing flag. Specifically, the jump determination unit 27 turns off the water landing flag (step ST11). The water landing flag is a flag indicating whether the jumped ship 1 lands on the water, and is stored in a rewritable manner, for example, in a storage device included in the higher-level control unit 23. Subsequently, the jump determination unit 27 determines whether the jumped ship 1 lands on the water (step ST12). Specifically, the jump determination unit 27 recognizes the current downward acceleration a of the ship 1 based on the detection signal output from the acceleration sensor 34, determines that the ship 1 that jumped lands on the water in a case where the acceleration a is equal to or less than the downward acceleration reference value Ath2, and determines that the ship 1 that jumped has not landed on the water in a case where it is determined that the acceleration a is not equal to or less than the downward acceleration reference value Ath2. As a result of this determination, in a case where the ship 1 that jumped lands on the water, the jump determination unit 27 turns on the water landing flag (step ST13), and ends the water landing determination process.

### (Regenerative Control Process)

In the regenerative control process, as illustrated in FIG. 6, processing related to the drive control of the motor 8 is performed (step ST21), and after this, the control of the motor 8 is switched (step ST22), and then, processing related to the regenerative control of the motor 8 is performed (steps ST23 to ST26). After this, the control of the motor 8 is switched (step ST27), and then processing related to drive control of the motor 8 is performed (steps ST28 and ST29). The contents of the regenerative control process will be explained in detail below.

In the regenerative control process, first, the drive control unit 25 sets the required drive torque d to 0 regardless of the current inclination angle of the operating lever 32 (step ST21).

Subsequently, the control switching command unit 24 outputs the regenerative control command signal c2 to the lower-level control unit 22 (step ST22). As a result, the state of the lower-level control unit 22 becomes a state where the regenerative control of the motor 8 is performed in cooperation with the regenerative control unit 26 of the higher-level control unit 23. That is, by outputting the regenerative control command signal c2, the drive control of the motor 8 is interrupted and the regenerative control of the motor 8 is started.

Subsequently, the regenerative control unit 26 determines the required regenerative torque initial value Gs based on the rotation speed increase rate r of the motor 8 at the start of jump of the ship 1 (step ST23). The regenerative control unit 26 sets the required regenerative torque initial value Gs greater as the rotation speed increase rate r of the motor 8 at the start of jump of the ship 1 is greater.

Subsequently, the regenerative control unit 26 sets the required regenerative torque g to the required regenerative torque initial value Gs, and outputs a command signal indicating the required regenerative torque g to the lower-level control unit 22 (step ST24). While the regenerative control of the motor 8 is being performed, the regenerative control unit 26 continuously outputs a command signal indicating the required regenerative torque g.

Subsequently, the regenerative control unit 26 gradually decreases the required regenerative torque g from the required regenerative torque initial value Gs until the rotation speed n of the motor 8 becomes equal to or less than a rotation speed NO of the motor 8 immediately before the ship 1 starts jumping. Specifically, the regenerative control unit 26 first decreases the required regenerative torque g by a predetermined unit amount (step ST25). Next, the regenerative control unit 26 recognizes the current rotation speed n of the motor 8 based on the detection signal output from the rotation detection unit 11, and determines whether the rotation speed n is equal to or less than the rotation speed NO of the motor 8 immediately before the ship 1 starts jumping (step ST26). The higher-level control unit 23 stores and accumulates the rotation speed of the motor 8 during the most recent period as a rotation speed memory value in the storage device of the higher-level control unit 23, and the rotation speed NO of the motor 8 immediately before the ship 1 starts jumping can be acquired from the rotation speed memory values stored in the memory device. When the current rotation speed n of the motor 8 is not equal to or less than the rotation speed NO of the motor 8 immediately before the ship 1 starts jumping, the process returns to step ST25, and the regenerative control unit 26 again reduces the required regenerative torque g by a predetermined unit amount. On the other hand, in a case where the current rotation speed n of the motor 8 is equal to or less than the pre-jump rotation speed NO, the process moves to step ST27.

In step ST27, the control switching command unit 24 outputs the drive control command signal c1 to the lower-level control unit 22. As a result, the state of the lower-level control unit 22 becomes a state where the drive control of the motor 8 is performed in cooperation with the drive control unit 25 of the higher-level control unit 23. That is, by outputting the drive control command signal c1, the regenerative control of the motor 8 ends, and the drive control of the motor 8 is restarted.

Subsequently, the drive control unit 25 starts outputting a command signal indicating the rotation direction instruction j and the required drive torque d to the lower-level control unit 22. Subsequently, the drive control unit 25 gradually increases the required drive torque d from 0 until the ship 1 that jumped lands on the water and thereafter the ship speed s of the ship 1 changes from decreasing to increasing. This process is a drive control process of the motor 8 that is independent of the operation of the operating lever 32, and the drive control unit 25 gradually increases the required drive torque d from 0 regardless of the current inclination angle of the operating lever 32. Specifically, the drive control unit 25 first increases the required drive torque d by a predetermined unit amount (step ST28). Subsequently, the drive control unit 25 determines whether the water landing flag is on and the ship speed s of the ship 1 changes from decreasing to increasing (step ST29). The drive control unit 25 determines whether the water landing flag is on by referring to the water landing flag stored in a storage device included in the higher-level control unit 23. Further, the drive control unit 25 determines whether the ship speed s of the ship 1 changes from decreasing to increasing by recognizing the change in the current ship speed s of the ship 1 based on the detection signal output from the ship speed sensor 33. In addition, the behavior of the ship 1 in which the ship 1 that jumped lands on the water and then the ship speed of the ship 1 changes from decreasing to increasing is the behavior when the ship 1 ends jumping and returns to the same state as immediately before the jump. In other words, after starting the jump, the ship 1 lands on the water and decelerates once due to the resistance of water applied to the ship 1 as a result of the landing on the water, and then starts acceleration by the propulsive force generated by the propeller 7, which is submerged in the water, rotating due to the power of the motor 8, and returns to the same state as immediately before the jump.

As a result of the determination in step ST29, in a case where the water landing flag is not on, or in a case where the water landing flag is on but the ship speed s of the ship 1 does not change from decreasing to increasing, the process returns to step ST28. Then, the drive control unit 25 increases the required drive torque d by a predetermined unit amount again. On the other hand, as a result of the determination in step ST29, in a case where the water landing flag is on and the ship speed s of the ship 1 changes from decreasing to increasing, the process returns to step ST1 in FIG. 4.

In a case where the ship 1 starts jumping again at the same time as the process returns to step ST1, immediately after the process returns to step ST1, it is determined in the jump start determination process that the ship 1 starts jumping, and the regenerative control process is executed again. However, considering that the processing speed of the higher-level control unit 23 is significantly faster than the behavior of the ship 1, such a situation is unlikely to occur. Normally, immediately after the process returns to step ST1, it is determined in the jump start determination process that the ship 1 has not started jumping, the process proceeds to step ST6, and the drive control process corresponding to the operation of the operating lever 32 is executed.

Here, the regenerative control process will be specifically explained using FIG. 7. At time t2 in FIG. 7, the jump determination unit 27 determines that the ship 1 starts jumping, and in accordance with this, the regenerative control process is started and the required drive torque d becomes 0. In addition, the state of the lower-level control unit 22 is switched to a state where the regenerative control of the motor 8 is performed in cooperation with the regenerative control unit 26 of the higher-level control unit 23. As a result, the drive control of the motor 8 is interrupted, but the rotor of the motor 8 continues to rotate due to inertia.

Furthermore, at time t2, the regenerative control of the motor 8 is started, and the required regenerative torque g set to the required regenerative torque initial value Gs is output to the lower-level control unit 22. When the required regenerative torque g set to the required regenerative torque initial value Gs is output to the lower-level control unit 22, in accordance with this, the lower level control unit 22 controls the motor 8 to generate a regenerative torque corresponding to the required regenerative torque g set in the required regenerative torque initial value Gs, the regenerative braking is applied to the motor 8, and an increase in the rotation speed of the motor 8 is suppressed.

In the graph of the rotation speed n at the bottom of FIG. 7, the solid line Ls1 illustrates the change in the rotation speed n in a case where the regenerative control process is performed, and the broken line Lb1 illustrates the change in the rotation speed n when the regenerative control process is not performed. The ship 1 starts jumping, the propeller 7 comes out of the water surface, the resistance of water applied to the propeller 7 disappears, and accordingly, the rotation speed n of the motor suddenly increases from time t1 to time t2. In a case where the regenerative control process is not performed, as illustrated by the broken line Lb1, the rotation speed n of the motor 8 continues to suddenly increase after time t2, and then the rotation speed n of the motor 8 reaches an excessively high rotation speed Np. On the other hand, in a case where the regenerative control process is being performed, as illustrated by the solid line Ls1, the regenerative braking is applied to the motor 8 at time t2, thereby suppressing the increase in the rotation speed n of the motor 8. As a result, the rotation speed n of the motor 8 does not reach an excessively high rotation speed Np. In this manner, when the ship 1 starts jumping, by applying the regenerative braking to the motor 8 by the regenerative control process, it is possible to suppress excessively high speed rotation of the motor 8.

In addition, in the regenerative control process, the regenerative control unit 26 sets the required regenerative torque initial value Gs greater as the rotation speed increase rate r of the motor 8 at time t1 is greater. Therefore, the greater the rotation speed increase rate r of the motor 8 at time t1, the greater the regenerative torque generated in the motor 8 at time t2, and as a result, the greater the braking force due to the regenerative braking applied to the motor 8. Thereby, even in a case where the rotation speed increase rate r of the motor 8 at the start of jump of the ship 1 is large, it is possible to reliably suppress an excessive increase in rotation speed of the motor 8.

Further, from time t2 to time t3 in FIG. 7, the required regenerative torque g gradually decreases due to the processing of the regenerative control unit 26. Therefore, from time t2 to time t3, the regenerative torque generated in the motor 8 gradually decreases, and as a result, from time t2 to time t3, the rotation speed n of the motor 8 slowly and gradually decreases, as illustrated by the solid line Ls1 of the graph of the rotation speed n. By gradually reducing the rotation speed n of the motor 8 from time t2, two effects can be obtained. The first effect is that after the ship 1 that jumped lands on the water, when the regenerative control process ends and the drive control process corresponding to the operation of the operating lever 32 is restarted, the rotation speed n of the motor 8 can suddenly and significantly increase, and occurrence of large vibrations in the ship 1 can be suppressed. The second effect is that the amount of regenerative power obtained by the regenerative operation of the motor 8 can be increased from when the ship 1 starts jumping until the ship 1 lands on the water.

Regarding the first effect, the drive control process corresponding to the operation of the operating lever 32 is performed until immediately before the ship 1 starts jumping. After the ship 1 starts jumping, the drive control process corresponding to the operation of the operating lever 32 is interrupted, and the regenerative control process is performed. Then, after the ship 1 that jumped lands on the water and the regenerative control process ends, the drive control process corresponding to the operation of the operating lever 32 is restarted. In addition, in the drive control process corresponding to the operation of the operating lever 32, in accordance with the operation of the operating lever 32 by the ship operator (the inclination angle of the operating lever 32), the required drive torque d is determined, the drive torque generated by the motor 8 is determined, the rotation speed n of the motor 8 is determined, and the magnitude of the propulsive force of the ship 1 is determined. Therefore, during the period from immediately before the drive control process corresponding to the operation of the operating lever 32 is interrupted due to the start of the jump of the ship 1 to immediately after the drive control process corresponding to the operation of the operating lever 32 is restarted, in a case where the ship operator does not operate the operating lever 32 (in a case where the inclination angle of the operating lever 32 has not changed), when the drive control process corresponding to the operation of the operating lever 32 is restarted, through the drive control of the motor 8 by the drive control unit 25, the required drive torque d, the drive torque of the motor 8, the rotation speed n of the motor 8, and the propulsive force of the vessel 1 return to the required drive torque d, the drive torque, the rotation speed n, and the propulsive force immediately before the drive control process corresponding to the operation of the operating lever 32 was interrupted due to the start of the jump of the ship 1. Therefore, at the time when the ship 1 that jumped lands on the water and then the regenerative control process ends, in a case where the rotation speed n of the motor 8 becomes the rotation speed close to the rotation speed n immediately before the drive control process corresponding to the operation of the operating lever 32 is interrupted due to the start of the jump of the ship 1, when the drive control process corresponding to the operation of the operating lever 32 is restarted, the rotation speed n of the motor 8 does not change suddenly or significantly, and accordingly, occurrence of large vibrations in the ship 1 can be suppressed.

In a case where the required regenerative torque g does not gradually decrease from time t2, the required regenerative torque initial value Gs is maintained from time t2, and thus the speed at which the rotation speed n of the motor 8 gradually decreases from time t2 becomes faster, and the rotation speed n of the motor 8 significantly decreases in an extremely short period of time from time t2. In a case where the rotation speed n of the motor 8 significantly decreases in an extremely short period of time from time t2, at the time when the ship 1 that jumped lands on the water and then the regenerative control process ends, the rotation speed n of the motor 8 may become significantly lower than the rotation speed n immediately before the drive control process corresponding to the operation of the operating lever 32 is interrupted due to the start of the jump of the ship 1. In that case, when the regenerative control process ends and the drive control process corresponding to the operation of the operating lever 32 is restarted, the rotation speed n of the motor 8 suddenly and significantly increases, and thus large vibrations may occur in the ship 1.

In contrast, in the motor control device 21 of the embodiment, after outputting the required regenerative torque g set to the required regenerative torque initial value Gs at time t2, the required regenerative torque g gradually decreases from time t2, and thus, the speed at which the rotation speed n of the motor 8 gradually decreases from time t2 is slowed down. By slowing down the rate at which the rotation speed n of the motor 8 gradually decreases in this manner, at the time when the ship 1 that jumped lands on the water and then the regenerative control process ends, the rotation speed n of the motor 8 can become a rotation speed close to the rotation speed n immediately before the drive control process corresponding to the operation of the operating lever 32 was interrupted due to the start of the jump of the ship 1. Therefore, when the drive control process corresponding to the operation of the operating lever 32 is restarted, it is possible to suppress the sudden and significant change in rotation speed n of the motor 8, and accordingly, it is possible to suppress occurrence of large vibrations in the ship 1.

Regarding the second effect obtained by gradually reducing the rotation speed n of the motor 8 from time t2, in a case where the required regenerative torque g does not gradually decrease from time t2, since the required regenerative torque initial value Gs is maintained from time t2, the rotation of the motor 8 may slow down or stop within an extremely short period of time from time t2. When the motor 8 rotates at a low speed, the regenerative power obtained by the regenerative operation of the motor 8 becomes small. Further, when the rotation of the motor 8 stops, the regenerative operation of the motor 8 is no longer performed, and regenerative power is no longer obtained. Therefore, in a case where the required regenerative torque g is not gradually reduced from time t2, the amount of regenerative power obtained by the regenerative operation of the motor 8 will decrease from when the ship 1 starts jumping until the ship 1 lands on the water. In contrast, in the motor control device 21 of the embodiment, after outputting the required regenerative torque g set to the required regenerative torque initial value Gs at time t2, the required regenerative torque g gradually decreases from time t2, and thus, the speed at which the rotation speed n of the motor 8 can gradually decrease from time t2 is slowed down. Accordingly, it is possible to prevent the rotation of the motor 8 from decreasing or stopping during the period from time t2 until the ship 1 lands on the water. Therefore, while the ship 1 is jumping, the regenerative operation of the motor 8 can be continued for a long time, and the amount of regenerative power obtained by the regenerative operation of the motor 8 can be increased.

Further, at time t3 in FIG. 7, the rotation speed n of the motor 8 is equal to or less than the rotation speed NO immediately before the ship 1 starts jumping. Then, the regenerative control unit 26 recognizes that the rotation speed n of the motor 8 is equal to or lower than the rotation speed NO immediately before the ship 1 starts jumping, and the state of the lower-level control unit 22 is switched to a state where the lower-level control unit 22 performs the drive control of the motor 8 in cooperation with the drive control unit 25 of the higher-level control unit 23. As a result, the regenerative control of the motor 8 ends, and the drive control of the motor 8 is restarted. When the rotation speed n of the motor 8 becomes equal to or lower than the rotation speed NO immediately before the ship 1 starts jumping, by ending the regenerative control of the motor 8, the rotation speed n of the motor 8 at the end of the regenerative control process can be brought close to the rotation speed NO immediately before the ship 1 starts jumping. Accordingly, when the drive control process corresponding to the operation of the operating lever 32 is restarted, it is possible to suppress the sudden and significant change in rotation speed n of the motor 8, and it is possible to suppress occurrence of large vibrations in the ship 1.

Then, at time t3, the drive control unit 25 executes the drive control process independent of the operation of the operating lever 32, thereby starting to gradually increase the required drive torque d from 0. Thereafter, at time t4, the ship 1 that jumped lands on the water. Since the ship 1 that jumped lands on the water, the downward acceleration a of the ship 1 becomes equal to or less than the downward acceleration reference value Ath2. At this time, in the water landing determination process that is executed in parallel with the regenerative control process, it is recognized that the ship 1 that jumped lands on the water based on the downward acceleration a of the ship 1, and the water landing flag is switched from off to on. Furthermore, the ship speed s of the ship 1 decreases from time t4 due to the resistance of water that the ship 1 receives when the ship 1 lands on the water. After that, at time t5, the ship speed s of the ship 1 changes from decreasing to increasing. At this time, in the regenerative control process, the drive control unit 25 recognizes that the water landing flag is on and that the ship speed s of the ship 1 changes from decreasing to increasing, and stops the gradual increase in the required drive torque d. Immediately after the regenerative control process ends, the drive control process corresponding to the operation of the operating lever 32 is restarted.

During the period from time t3 when the regenerative control of the motor 8 ends to time t5 when the ship 1 lands on the water and then the ship speed s of the ship 1 changes from decreasing to increasing, the drive control unit 25 performs a process of gradually increasing the required drive torque d from 0. Hereinafter, this process will be referred to as “required drive torque gradual increase process”. Due to the required drive torque gradual increase process, the drive torque generated by the motor 8 gradually increases from time t3 to time t5. Accordingly, it is possible to suppress a decrease in the ship speed s due to the landing of the ship 1 on the water, and it is possible to suppress the vibration of the ship 1 when the ship 1 that jumped lands on the water. In the graph of the ship speed s which is the second from the bottom of FIG. 7, the solid line Ls2 illustrates the change in the ship speed s in a case where the required drive torque gradual increase process is performed, and the broken line Lb2 illustrates the change in the ship speed s in a case where the required drive torque gradual increase process is not performed. When the ship 1 that jumped lands on the water, the resistance of water is applied to the ship 1, and the ship speed s of the ship 1 decreases. In a case where the required drive torque gradual increase process is not performed, when the ship 1 lands on the water, the drive torque generated by the motor 8 is small, and thus the ship speed s decreases significantly as indicated by the broken line Lb2. On the other hand, in a case where the required drive torque gradual increase process is performed, when the ship 1 lands on the water, the drive torque generated by the motor 8 increases (or the drive torque has already increased to a certain extent and becomes larger), the decrease in ship speed s becomes smaller as indicated by the solid line Ls2. Therefore, by performing the required drive torque gradual increase process, it is possible to suppress the vibration of the ship 1 when the ship 1 that jumped lands on the water.

Furthermore, at time t5, it is recognized that the water landing flag is on and the ship speed s of the ship 1 changes from decreasing to increasing, the required drive torque gradual increase process and the regenerative control process end, and accordingly, it is possible to transition quickly and smoothly from the regenerative control process to the drive control process based on the operation of the operating lever 32.

Incidentally, when the ship 1 jumps, the rotation speed n of the motor 8 becomes equal to or less than the rotation speed NO immediately before the jump before the ship 1 that jumped lands on the water, the rotation speed n of the motor 8 may not become equal to or less than the rotation speed NO immediately before the jump before the ship 1 that jumped lands on the water. FIG. 7 illustrates an example of a case where, before the ship 1 that jumped lands on the water, the rotation speed n of the motor 8 becomes equal to or less than the rotation speed NO immediately before the jump. On the other hand, FIG. 8 illustrates an example of a case where, before the ship 1 that jumped lands on the water, the rotation speed n of the motor 8 does not become equal to or less than the rotation speed NO immediately before the jump.

In FIG. 8, the period from time t11 to immediately before time t13 is the same as the period from time t1 to immediately before time t3 in FIG. 7. At time t13, the ship 1 that jumped lands on the water. Since the ship 1 that jumped lands on the water, the downward acceleration a of the ship 1 becomes equal to or less than the downward acceleration reference value Ath2. At this time, in the water landing determination process that is executed in parallel with the regenerative control process, it is recognized that the ship 1 that jumped lands on the water, and the water landing flag is switched from off to on. Furthermore, the ship speed s of the ship 1 decreases from time t13 due to the resistance of water that the ship 1 receives when the ship 1 lands on the water. Furthermore, the rotation speed n of the motor 8 suddenly decreases from time t13 due to the resistance of water that the propeller 7 receives when the ship 1 lands on the water. After that, at time t14, the rotation speed n of the motor 8 is equal to or less than the rotation speed NO immediately before the ship 1 starts jumping. Then, the regenerative control unit 26 recognizes that the rotation speed n of the motor 8 is equal to or lower than the rotation speed NO immediately before the ship 1 starts jumping, and the state of the lower-level control unit 22 is switched to a state where the lower-level control unit 22 performs the drive control of the motor 8 in cooperation with the drive control unit 25 of the higher-level control unit 23. As a result, the regenerative control of the motor 8 ends, and the drive control of the motor 8 is restarted. Then, at time t14, the drive control unit 25 executes the drive control process independent of the operation of the operating lever 32, thereby starting to gradually increase the required drive torque d from 0. After that, at time t15, the ship speed s of the ship 1 changes from decreasing to increasing. At this time, in the regenerative control process, the drive control unit 25 recognizes that the water landing flag is on and that the ship speed s of the ship 1 changes from decreasing to increasing, and stops the gradual increase in the required drive torque d. Immediately after the regenerative control process ends, the drive control process corresponding to the operation of the operating lever 32 is restarted.

In this manner, even in a case where the rotation speed n of the motor 8 does not become equal to or less than the rotation speed NO immediately before the jump before the ship 1 that jumped lands on the water, the motor control device 21 achieves the same effect as in the case where the rotation speed n of the motor 8 becomes equal to or less than the rotation speed NO immediately before the jump before the ship 1 that jumped lands on the water.

As described above, the motor control device 21 according to the embodiment of the present disclosure performs the regenerative control of the motor 8 when the ship 1 jumps. Thereby, it is possible to increase opportunities or time for the motor 8 to perform the regenerative operation. Therefore, the amount of regenerative power obtained by the regenerative operation of the motor 8 can be increased. The regenerative power obtained by the regenerative operation of the motor 8 can be stored in an electric storage device such as a battery or a capacitor and then used to drive the motor 8, thereby extending the cruising distance of the ship 1.

In addition, the regenerative braking can be applied to the motor 8 through the regenerative control, and an increase in rotation speed of the motor 8 when the ship 1 jumps can be suppressed. Accordingly, when the ship 1 jumps, it is possible to suppress excessively high speed rotation of the motor 8, and it is possible to suppress the adverse effect on the motor 8 or the like caused by excessively high speed rotation.

In addition, by gradually reducing the regenerative torque generated in the motor 8 through the regenerative control, the rotation of the motor 8 is prevented from slowing down or stopping while the ship 1 is jumping, and the regenerative operation of the motor 8 is extended for a long period of time. Accordingly, the amount of regenerative power obtained by the regenerative operation of the motor 8 can be increased while suppressing excessively high speed rotation of the motor.

In the above embodiment, in the regenerative control process, the required regenerative torque initial value Gs is determined based on the rotation speed increase rate r of the motor 8 at the start of jump of the ship 1, and specifically, the required regenerative torque initial value Gs is set to be greater as the rotation speed increase rate r is greater. However, the present disclosure is not limited to this. The required regenerative torque initial value Gs may be a predetermined constant value.

Further, in the above embodiment, the required regenerative torque g gradually decreases in the regenerative control process. However, the present disclosure is not limited to this. For example, after outputting the required regenerative torque g set to the required regenerative torque initial value Gs, the required regenerative torque g is quickly reduced to a predetermined value greater than 0 and less than the required regenerative torque initial value Gs. Thereafter, the required regenerative torque g may be maintained at the predetermined value until the rotation speed n of the motor 8 becomes equal to or less than the rotation speed NO of the motor 8 immediately before the ship 1 starts jumping.

Further, in the above embodiment, the jump determination unit 27 determines that the ship 1 starts jumping in a case where all of the conditions (1) to (5) are satisfied, that is, (1) the condition that the upward acceleration a of the ship 1 is equal to or greater than the predetermined upward acceleration reference value Ath1, (2) the condition that the ship speed s of the ship 1 is equal to or greater than the predetermined ship speed reference value Sth, (3) the condition that the required drive torque d is equal to or greater than the predetermined required drive torque reference value Dth, (4) the condition that the rotation speed increase rate r per unit time of the motor 8 is equal to or greater than the predetermined rotation speed increase rate reference value Rth, and (5) the condition that the rotation speed n of the motor 8 is the predetermined rotation speed reference value Nth, are satisfied, the jump determination unit 27 determines that the ship 1 starts jumping. However, the present disclosure is not limited to this. It may be determined that the ship 1 starts jumping in a case where some of the above five conditions are satisfied. For example, it may be determined that the ship 1 starts jumping in a case where all of the conditions (1), (4), and (5) above are satisfied, it may be determined that the ship 1 starts jumping in a case where all of the conditions (2), (4), and (5) above are satisfied, it may be determined that the ship 1 starts jumping in a case where all of the conditions (3), (4), and (5) above are satisfied, and it may be determined that the ship 1 starts jumping in a case where all of the conditions (4), and (5) above are satisfied. In addition, when determining whether the ship 1 starts jumping, in addition to the upward acceleration a of the ship 1, the ship speed s, the required drive torque d, the rotation speed increase rate per unit time r of the motor 8, and the rotation speed n of the motor 8, a detected value or a controlled value indicating the behavior of the ship 1 or the electric outboard motor 6 may be used. For example, when determining whether the ship 1 starts a jump, it may be determined whether the ship 1 is moving forward based on the rotation direction instruction j (that is, the condition for determining that the ship 1 starts jumping may be added to the condition that the ship 1 is moving forward).

Further, in the above embodiment, in the regenerative control process, when the rotation speed n of the motor 8 becomes equal to or less than the rotation speed NO of the motor 8 immediately before the ship 1 starts jumping, the regenerative control of the motor 8 ends. However, the present disclosure is not limited to this. For example, the regenerative control of the motor 8 may end when it is determined that the ship 1 that jumped lands on the water.

Further, in the above embodiment, it is determined whether the ship 1 that jumped lands on the water based on the downward acceleration of the ship 1. However, the present disclosure is not limited to this. The ship speed or the rotation speed of the motor may be used to determine whether the ship 1 that jumped lands on the water.

Further, in the above embodiment, in the regenerative control process, when the ship 1 lands on the water and then the ship speed s changes from decreasing to increasing, the required drive torque gradual increase process is stopped. However, the present disclosure is not limited to this. For example, the required drive torque gradual increase process may be stopped after a predetermined period of time set in advance elapses since the ship 1 lands on the water.

Furthermore, the present disclosure can be modified as appropriate within the scope that does not contradict the gist or concept of the disclosure that can be read from the claims and the entire specification, and motor control devices for electric propulsion units that involve such modifications are also included in the technical concept of the present disclosure.

What is claimed is:

1. A motor control device for an electric propulsion machine, the motor control device being configured to control a motor of the electric propulsion machine, the electric propulsion machine comprising a propeller and the motor configured to rotate the propeller, the motor control device comprising:
a drive control unit configured to perform drive control of the motor to rotate the propeller;
a jump determination unit configured to determine whether a ship equipped with the electric propulsion machine jumps; and
a regenerative control unit configured to perform regenerative control of the motor in response to the ship being determined to jump as a result of a determination by the jump determination unit.

2. The motor control device for an electric propulsion machine according to claim 1,
wherein in the regenerative control of the motor, the regenerative control unit is configured to set a regenerative torque of the motor greater as a rotation speed increase rate of the motor at a start of jump of the ship is greater.

3. The motor control device for an electric propulsion machine according to claim 1,
wherein in the regenerative control of the motor, the regenerative control unit is configured to generate a regenerative torque in the motor when the ship starts jumping, and then gradually reduce the regenerative torque.

4. The motor control device for an electric propulsion machine according to claim 1,
wherein the jump determination unit is configured to determine that the ship starts jumping in a case where a rotation speed increase rate of the motor is equal to or greater than a predetermined rotation speed increase rate reference value, and a rotation speed of the motor increases to a predetermined rotation speed reference value or greater.

5. The motor control device for an electric propulsion machine according to claim 1,
wherein the jump determination unit is configured to determine that the ship starts jumping in a case where a speed of the ship is equal to or greater than a predetermined ship speed reference value, a rotation speed increase rate of the motor is equal to or greater than a predetermined rotation speed increase rate reference value, and a rotation speed of the motor increases to a predetermined rotation speed reference value or greater.

6. The motor control device for an electric propulsion machine according to claim 1,
wherein in the drive control of the motor, the drive control unit is configured to drive the motor such that the motor generates a drive torque in accordance with a required drive torque corresponding to an operation amount of an operation device configured to operate the electric propulsion machine, and
wherein the jump determination unit is configured to determine that the ship starts jumping in a case where the required drive torque is equal to or greater than a predetermined required drive torque reference value, a rotation speed increase rate of the motor is equal to or greater than a predetermined rotation speed increase rate reference value, and a rotation speed of the motor increases to a predetermined rotation speed reference value or greater.

7. The motor control device for an electric propulsion machine according to claim 1,
wherein the jump determination unit is configured to determine that the ship starts jumping in a case where an upward acceleration of the ship is equal to or greater than a predetermined upward acceleration reference value, a rotation speed increase rate of the motor is equal to or greater than a predetermined rotation speed increase rate reference value, and a rotation speed of the motor increases to a predetermined rotation speed reference value or greater.

8. The motor control device for an electric propulsion machine according to claim 1,
wherein the regenerative control unit is configured to end the regenerative control of the motor when a rotation speed of the motor, which increases due to the ship jumping, decreases to a value equal to or less than the rotation speed immediately before the ship jumps.

9. The motor control device for an electric propulsion machine according to claim 1,
wherein the drive control unit is configured to gradually increase a drive torque of the motor after the regenerative control of the motor ends.

10. The motor control device for an electric propulsion machine according to claim 9,
wherein the jump determination unit is configured to determine whether the ship that jumped lands on water, and
wherein the drive control unit is configured to end control of gradually increasing the drive torque of the motor when a speed of the ship changes from decreasing to increasing after the ship that jumped is determined to land on water as a result of the determination by the jump determination unit.
